(19) United States
(12) Patent Application Publication
(10) Pub. No.: US 2009/0139500 A1
(43) Pub. Date: Jun. 4, 2009

(54) EXHAUST GAS RECIRCULATION SYSTEM

(75) Inventor: Phillp F. Gronberg, Sugar Grove, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 11/949,100

(22) Filed: Dec. 3, 2007

(51) Int. Cl. F02B 47/08

(52) U.S. Cl. 123/568.12

(57) ABSTRACT

An exhaust gas recirculation system for reducing emissions which includes an exhaust portion having an outlet housing for collecting exhaust gas from an exhaust manifold of an internal combustion engine. The system also includes an intake portion having an inlet housing for introducing air into an intake manifold of an engine. The system also includes a fluid conduit for transporting exhaust gases from the exhaust portion to the intake portion. The conduit includes a first end and a second end. The first end is connected to the outlet housing with a slip joint and the second end is connected to the inlet housing with a slip joint, without the need for intermediate bracing. The system includes a plurality of sealing members for sealing the system and allowing for thermal expansion. The sealing members connect the first end to the outlet housing and connect the second end to the inlet housing.

### FIELD OF THE INVENTION

The present invention relates to an exhaust gas recirculation system for reducing emissions, and more particularly to a slip fit exhaust gas recirculation crossover conduit.

### BACKGROUND

The recirculation of exhaust gases from an exhaust manifold to the intake portion of an internal combustion engine is referred to as an Exhaust Gas Recirculation (EGR) system. Exhaust gases from the engine include not only carbon monoxide (CO) but also nitrogen oxide and nitrogen dioxide, which are commonly known as NOx. Once the exhaust gases are transported to the intake manifold of the internal combustion engine, they are mixed with fresh air at a carburetor or fuel injection state where they continue to the intake ports of the cylinder heads.

In the past, due to both thermal expansion and vibration, EGR systems required extensive bracketing and expansion bellows to manage engine heat and vibration. Thus, in order to reduce system component and manufacturing costs, an improved system is required to eliminate the complexities of prior EGR systems.

### SUMMARY

The present inventing is directed to an exhaust gas recirculation system for reducing emissions. The system includes an exhaust portion for collecting exhaust gases from an exhaust manifold of an internal combustion engine. The exhaust portion includes an outlet housing in addition to an intake portion and inlet housing for introducing air into an intake manifold of an internal combustion engine. The system further includes a fluid conduit for transporting exhaust gases from the exhaust portion to the intake portion. The conduit includes a first end that is connected to the outlet housing with a slip joint as well as a second end connected to the inlet housing with a slip joint. An advantage of the invention is that the conduit is connected to the outlet housing and the inlet housing without the need for intermediate bracing. The system also includes a plurality of sealing members for sealing the system and allowing for thermal expansion of the conduit. The sealing members connect the first end to the outlet housing and connect the second end to the inlet housing.

A pulsed crossover conduit is further used for recirculating exhaust gases into the internal combustion engine. The conduit is adapted to transport exhaust gases from an exhaust portion to an intake portion and is divided into a first chamber and a second chamber. The conduit includes a first end and a second end where the first end is adapted to connect to the exhaust portion with a slip joint and the second end is adapted to connect to the intake portion with a slip joint.

### BRIEF DESCRIPTION OF DRAWINGS

FIG. 1 is top perspective view of an embodiment of an exhaust gas recirculation system.

FIG. 2 is partial side view of an embodiment of an exhaust gas recirculation system.

FIG. 3 is a partial cross-sectional side view of an alternative embodiment of an exhaust gas recirculation system.

FIG. 4 is a partial cross-sectional side view of an alternative embodiment of the pulsed crossover conduit from FIG. 3.

FIG. 5 is a partial perspective view of an alternative embodiment of a pulsed crossover conduit.

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

### DETAILED DESCRIPTION OF PREFERRED EMBODIMENTS

The best mode for carrying out the claimed invention is presented below. Before describing in detail embodiments that are in accordance with the present invention, it should be observed that the embodiments reside primarily in combinations of method steps. In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

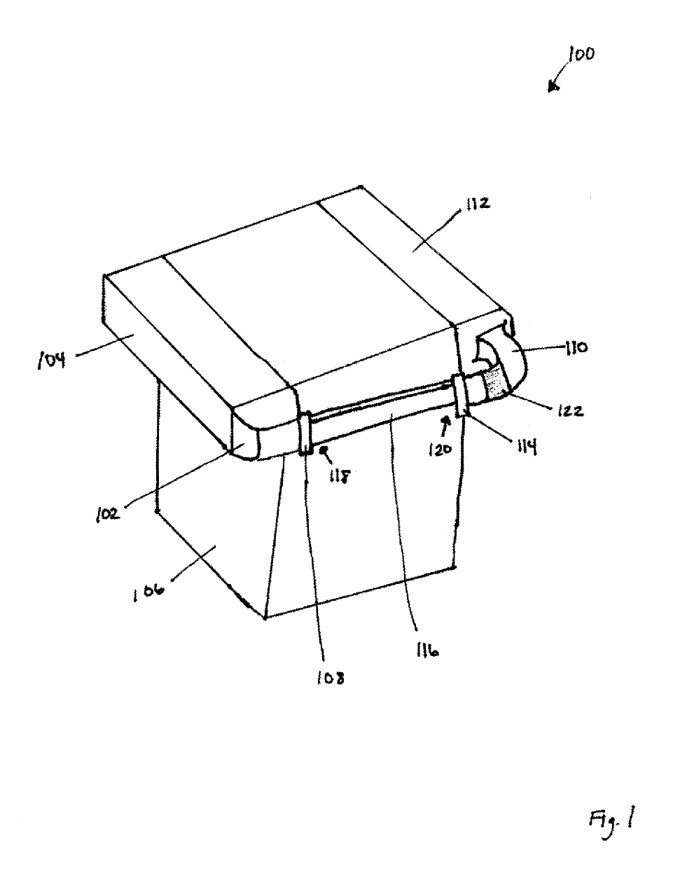

Referring now to the drawings, particularly FIG. 1, there is shown an embodiment of an exhaust gas recirculation (EGR) system 100. The EGR system 100 includes an exhaust portion 102 for collecting exhaust gas from an exhaust manifold 104 of an internal combustion engine 106. The exhaust manifold 104 is in fluid communication with the exhaust portion 102. The exhaust portion includes an outlet housing 108. The system also includes an intake portion 110 for introducing air into an intake manifold 112 of an internal combustion engine for combustion. The intake portion includes an inlet housing 114.

The EGR system 100 of the present invention may be installed on any internal combustion engine 106 known in the art, including but not limited to, inline, straight bore, V-type or horizontally opposed engines. The internal combustion engine 106 may also include various amounts of cylinders, including but not limited to, six or eight cylinders. The internal combustion engine 106 may also include gasoline, diesel or alternative fuel engines.

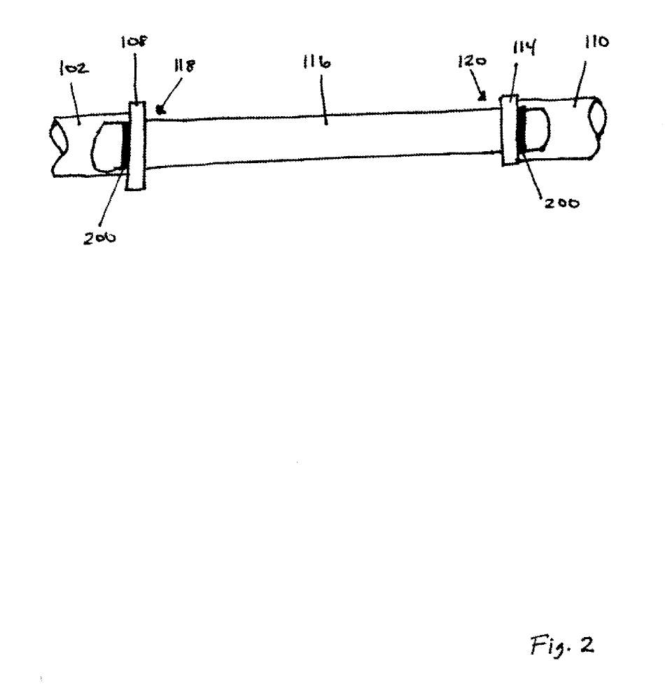

The system further includes a fluid conduit 116 for transporting exhaust gases from the exhaust portion 102 to the intake portion 110, as shown in FIGS. 1 and 2. In one embodiment, the conduit 116 is substantially straight. In an alternative embodiment, the conduit is twisted or bent. The conduit 116 may also be a variety of cross-sectional shapes, including but not limited to square, rectangular, tubular, or oval.

The conduit 116 may be made of any type of material known in the art which would be able to withstand tolerance variations and thermal expansion of the exhaust gases from the internal combustion engine 106. In one embodiment, the conduit 116 may be constructed of sheet metal stock. In an alternative embodiment, the conduit 116 may be a hydroform conduit. Hydroforming may include a specialized type of die forming that uses a high pressure hydraulic fluid to press room temperature working material into a die.

As also shown in FIGS. 1 and 2, the conduit 116 includes a first end 118 and a second end 120. As shown in FIG. 2, the system includes a plurality of sealing members 200 for sealing the system and allowing for thermal expansion of the conduit 116. The sealing members 200 connect the first end 118 to the outlet housing 108 and connect the second end 120 to the inlet housing 114 via a slip joint. A slip joint joins two structures while allowing for movement, extension and/or compression of a structure relative to another structure. The slip joint allows the conduit 116 to float or slide within the outlet housing 108 and inlet housing 114. In one embodiment, the conduit 116 is connected to the outlet housing 108 and the inlet housing 114 without the need for intermediate bracing. The slip joint also allows the conduit 116 to withstand thermal expansion and vibrations, and provides for easy assembly of the conduit 116 into the EGR system 100. Since the slip joint provides for thermal expansion and compression, in one embodiment, the conduit 116 does not utilize expansion bellows.

The sealing members 200 may comprise any material known in the art which can withstand the temperature and pressure of the particular application. In one embodiment, the sealing members 200 may be constructed of an o-ring made of an elastomer or like material.

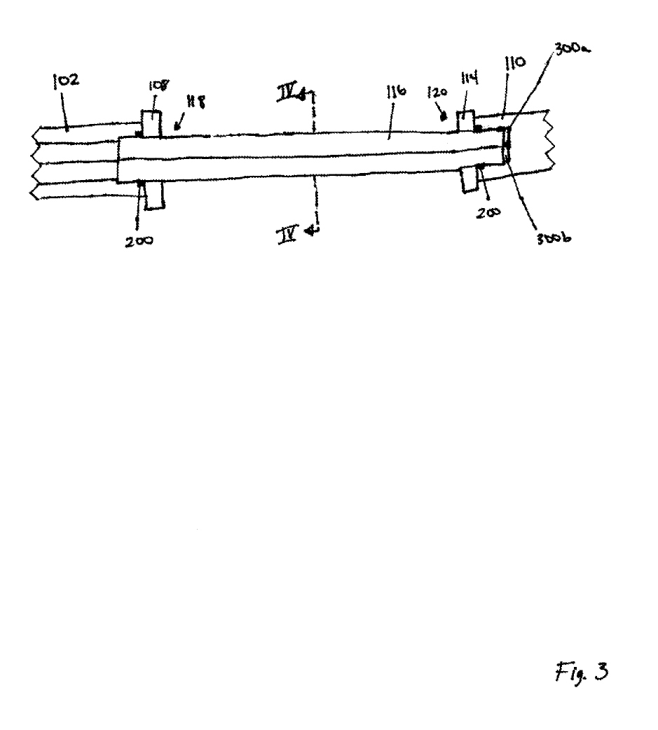

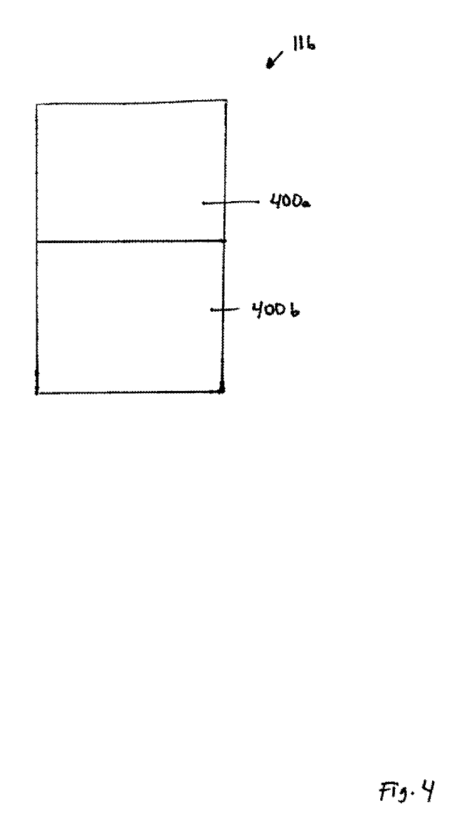

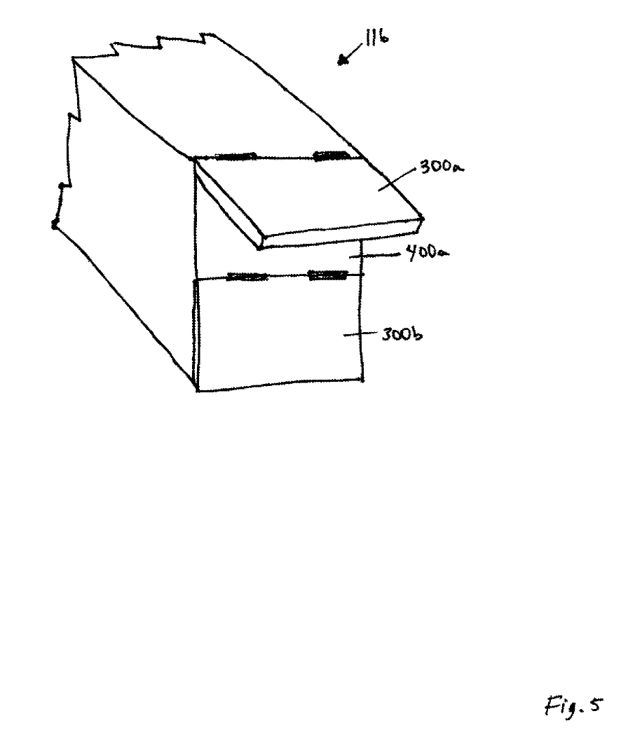

As shown in FIGS. 3-5, in an alternative embodiment, the conduit 116 may comprise a pulsed crossover conduit. As shown in FIGS. 4-5, in this embodiment, the conduit 116 is divided into a plurality of chambers 400. The chambers are adapted to receive exhaust gases from the exhaust portion 102 of the internal combustion engine 106. In this embodiment, the chambers 400 are in fluid communication with a predetermined amount of cylinders in the internal combustion engine 106. One having ordinary skill in the art may vary the performance and complexity of the pulsed crossover conduit depending upon the amount of cylinders in the internal combustion engine 106 and the amount of chambers 400 in the conduit 116.

In an alternative embodiment, the conduit 116 is divided into a first chamber 400a and a second chamber 400b. The first chamber 400a is adapted to receive exhaust gases from a first half of the internal combustion engine's cylinders and the second chamber 400b is adapted to receive exhaust gases from a second half of the internal combustion engine's cylinders. In a six cylinder engine of this embodiment, the first chamber 400a is adapted to receive exhaust gases from the first three cylinders and the second chamber 400b is adapted to receive exhaust gases from the second three cylinders. In this embodiment, the first chamber 400a is in fluid communication with the first three cylinders and the second chamber 400b is in fluid communication with the second three cylinders. In an alternative eight cylinder engine embodiment, the first chamber 400a is adapted to receive exhaust gases from the first four cylinders and the second chamber 400b is adapted to receive exhaust gases from the second four cylinders. In this embodiment, the first chamber 400a is in fluid communication with the first four cylinders and the second chamber 400b is in fluid communication with the second four cylinders.

As shown in FIGS. 3 and 5, in the pulsed crossover conduit embodiment, the conduit may comprise a plurality of end valves 300 which are located on the second end 120 of each chamber 400. In one embodiment, the end valves 300 comprise reed valves. The end valves 300 are adapted to alternatively release exhaust gases from the chambers 400. The end valves 300 allow the chambers 400 to accumulate exhaust gases from the exhaust portion until a predetermined pressure is reached. Once the pressure in the chamber 400 reaches the predetermined amount, the end valve 300 pulses the exhaust gases from the chamber and creates more instantaneous injection of the exhaust gases into the intake portion 110. One having ordinary skill in the art may vary the predetermined amount of pressure required to open or pulse the end valves 300 depending on desired results, including the type of engine, amount of cylinders, and amount of chambers 400 within the conduit 116.

In an alternative embodiment, as shown in FIG. 5, the conduit 116 includes a first end valve 300a and a second end valve 300b. In this embodiment, the first end valve 300a is connected to the first chamber 400a at the second end 120 of the conduit 116 and the second end valve 300b is connected to the second chamber 400b at the second end 120 of the conduit 116.

In an alternative embodiment, the EGR system 100 may also include an EGR cooler 122, as shown in FIG. 1. Although the temperature of the exhaust gases may be reduced while they are transported through the conduit 116, one having ordinary skill in the art my include one or a plurality of EGR coolers 124 in the EGR system 100 to lower the temperature of the exhaust gases before they enter the intake portion 110. In one embodiment, the EGR cooler 122 may be in fluid communication with the conduit 116. In alternative embodiments, an EGR cooler 122 may be located upstream or downstream (as shown in FIG. 1) from the conduit 116.

Hence, the present invention is direct to an exhaust gas recirculation system for reducing emissions. In one embodiment the invention includes an exhaust portion for collecting exhaust gases from an exhaust manifold of an internal combustion engine and an intake portion for introducing air into an intake manifold. A fluid conduit is used for transporting exhaust gases from the exhaust portion to the intake portion where the conduit connects to an inlet housing and outlet housing with a slip joint without the need for intermediate bracing. Finally, one or more sealing members are used for sealing the system and allowing for thermal expansion of the conduit.

While preferred embodiments and example configurations have been shown and described, it is to be understood that various further modifications and additional configurations will be apparent to those skilled in the art. It is intended that the specific embodiments and configurations disclosed are illustrative of the preferred and best modes for practicing the invention, and should not be interpreted as limitations on the scope of the invention as defined by the appended claims and it is to be appreciated that various changes, rearrangements and modifications may be made therein, without departing from the scope of the invention as defined by the appended claims.

1. An exhaust gas recirculation system for reducing emissions, the system comprising:
an exhaust portion for collecting exhaust gases from an exhaust manifold of an internal combustion engine, the exhaust portion having an outlet housing;
an intake portion for introducing air into an intake manifold of an internal combustion engine for combustion, the intake portion having an inlet housing;
a fluid conduit for transporting exhaust gases from the exhaust portion to the intake portion, the conduit having two or more separate chambers through which the exhaust gas passes, each of the chambers having a cooling component in communication therewith.

2. The exhaust gas recirculation system of claim 1, wherein a first one or more chambers configured to receive exhaust gases from a first group of cylinders and a second one or more chambers configured to receive exhaust gas from a second group of cylinders.

3. The exhaust gas recirculation system of claim 1, the fluid conduit comprising a hydroform conduit suitable for transporting exhaust gas.

4. The exhaust gas recirculation system of claim 1, wherein the conduit is substantially straight.

5. The exhaust gas recirculation system of claim 1, wherein the conduit does not utilize expansion bellows.

6. The exhaust gas recirculation system of claim 1, further comprising a cooling component, the cooling component in communication with the conduit.

7. The exhaust gas recirculation system of claim 1, the conduit divided into a plurality of chambers.

8. The exhaust gas recirculation system of claim 1, the conduit divided into a first chamber and a second chamber.

9. The exhaust gas recirculation system of claim 1, further comprising a first end valve and a second end valve, the first end valve connected to the first chamber at the second end of the conduit, the second end valve connected to the second chamber at the second end of the conduit, the end valves adapted to alternatively release exhaust gases.

10. The exhaust gas recirculation system of claim 1, the first chamber adapted to receive exhaust gases from a first half of the internal combustion engine's cylinders, the second chamber adapted to receive exhaust gases from a second half of the internal combustion engine's cylinders.

11. The exhaust gas recirculation system of claim 1, the first chamber and the second chamber comprising equal volumes.

12. A pulsed crossover conduit for recirculating exhaust gases into an internal combustion engine, the conduit comprising:
a conduit adapted to transport exhaust gases from an exhaust portion to an intake portion, the conduit divided into a first chamber and a second chamber, the conduit having a first end and a second end, the first end adapted to connect to the exhaust portion and the second end adapted to connect to the intake portion.

13. The crossover pipe of claim 12, the conduit is adapted to connect to the exhaust portion and the intake portion without the need for intermediate bracing.

14. The crossover pipe of claim 12, the first chamber adapted to receive gases from a first half of the internal combustion engine's cylinders, the second chamber adapted to receive gases from a second half of the internal combustion engine's cylinders.

15. The crossover pipe of claim 14, the first half of the internal combustion engine's cylinders comprise at least three cylinders.

16. The crossover pipe of claim 4, the first half of the internal combustion engine's cylinders comprise four cylinders.

17. The crossover pipe of claim 12, the first chamber and the second chamber comprising equal volumes.

18. The crossover pipe of claim 12, the conduit further comprising a first end valve and a second end valve, the first end valve connected to the first chamber at the second end of the conduit, the second end valve connected to the second chamber at the second end of the conduit, the end valves adapted to alternatively release exhaust gases.

19. The crossover pipe of claim 17, wherein the conduit does not utilize expansion bellows.

20. The crossover pipe of claim 19, wherein the conduit is substantially straight.
